(19) United States
(12) Patent Application Publication
(10) Pub. No.: US 2026/0055649 A1
(43) Pub. Date: Feb. 26, 2026

(54) SHOWER DOOR HARDWARE COVER, KIT, AND DISPLAY

(71) Applicant: LIBERTY HARDWARE MFG. CORP., Winston-Salem, NC (US)

(72) Inventors: John DUTTON, Winston-Salem, NC (US); Nathaniel Faltin Dutton SCHULTZ, Charlotte, NC (US); Edward RIDDLE, Winston-Salem, NC (US); Megan STREBA, Winston-Salem, NC (US); James K. PRUITT, Winston-Salem, NC (US)

(21) Appl. No.: 19/310,381

(22) Filed: Aug. 26, 2025

Related U.S. Application Data
(60) Provisional application No. 63/687,020, filed on Aug. 26, 2024.

(51) Int. Cl. E05D 15/06; A47F 7/00; A47K 3/34

(52) U.S. Cl. CPC E05D 15/063; A47F 7/0042; A47K 3/34; E05Y 2201/11; E05Y 2900/114

(57) ABSTRACT

A kit is provided with a first cover having a body sized to mount to hardware of a shower door assembly, the first cover having an external surface with a first design. A second cover has a body sized to mount to the hardware, the second cover having an external surface with a second design. One of the covers is provided with a body with a receptacle sized to fasten to a roller or a bracket of a variety of shower door roller assemblies. A retail display assembly is provided with a post defining one end of a display opening to receive a plurality of shower door assembly packages. A door is pivotally attached to the post to at least partially cover at least one of the plurality of shower door assembly packages. An information panel partially covers at least one of the plurality of shower door assembly packages.

### CROSS-REFERENCE TO RELATED APPLICATIONS

This application claims the benefit of U.S. provisional application Ser. No. 63/687,020 filed Aug. 26, 2024, the disclosure of which is hereby incorporated in its entirety by reference herein.

### TECHNICAL FIELD

Various embodiments relate to shower door assemblies, hardware, kits, and displays.

### BACKGROUND

Austin, III, et al., U.S. Pat. No. 12,144,441 B2, issued to Liberty Hardware Mfg. Corp., on Nov. 19, 2024 discloses a shower door assembly display.

### SUMMARY

According to an embodiment, a kit is provided with a first cover having a body sized to mount to hardware of a shower door assembly, the first cover having an external surface with a first design. A second cover has a body sized to mount to the hardware, the second cover having an external surface with a second design.

According to a further embodiment, the first design has a first shape; and the second design has a second shape that is different than the first shape.

According to an even further embodiment, the first cover is provided with a second retainer to cooperate with a first retainer of the hardware to retain the first cover upon the hardware. The second cover is provided with a third retainer to cooperate with the first retainer to retain the second cover upon the hardware.

According to another even further embodiment, the second retainer is provided with a slot sized to receive a lug of the hardware. The third retainer is provided with a slot sized to receive the lug.

According to another even further embodiment, the first cover is provided with a first receptacle sized to receive a bracket of the hardware, and wherein the second retainer is provided in the first receptacle. The second cover is provided with a second receptacle sized to receive the bracket, and wherein the third retainer is provided in the second receptacle.

According to another embodiment, a shower door assembly is provided with a rail, a first shower door pane, and a first roller assembly connected to the first shower door pane to support the first shower door pane for translation upon the rail. The first roller assembly is provided with a first roller and first hardware. A kit is provided with a first cover having a body sized to mount to the hardware of the shower door assembly, the first cover having an external surface with a first design. A second cover has a body sized to mount to the hardware, the second cover having an external surface with a second design.

According to a further embodiment, the hardware is provided as a bracket.

According to an even further embodiment, the bracket is further provided with a first retainer. The first cover is provided with a second retainer to cooperate with the first retainer to retain the first cover upon the bracket. The second cover is provided with a third retainer to cooperate with the first retainer to retain the second cover upon the bracket.

According to another even further embodiment, the first retainer is further provided with a pair of spaced apart retainers.

According to another further embodiment, the first retainer is further provided as a lug.

According to an even further embodiment, the second retainer is provided with a slot sized to receive the lug. The third retainer is provided with a slot sized to receive the lug.

According to an even further embodiment, the first cover is provided with a first receptacle sized to receive the bracket, and wherein the second retainer is provided in the first receptacle. The second cover is provided with a second receptacle sized to receive the bracket, and wherein the third retainer is provided in the second receptacle.

According to another further embodiment, a second roller assembly is connected to the first shower door pane to support the first shower door pane for translation upon the rail. The second roller assembly is provided with a second roller and second hardware.

According to another further embodiment, a second shower door pane is provided. A second roller assembly is connected to the second shower door pane to support the second shower door pane for translation upon the rail.

According to another embodiment, a cover is provided with a body with a receptacle sized to fasten to a roller or a bracket of a variety of shower door roller assemblies.

According to yet another embodiment, a method of decorating a shower door assembly removes a first cover from hardware of a shower door assembly. A second cover is installed upon the hardware with a design that is different from a design of the first cover.

According to a further embodiment, the first cover is slid along the hardware to unfasten the hardware.

According to an even further embodiment, the first cover is moved away from the hardware to remove the hardware from a slot within the first cover.

According to another embodiment, a retail display assembly is provided with a post defining one end of a display opening to receive a plurality of shower door assembly packages within the display opening. A door is pivotally attached to the post to at least partially cover at least one of the plurality of shower door assembly packages.

According to another further embodiment, an information panel is supported upon the door.

According to another further embodiment, a sample miniature shower door assembly is supported upon the door.

According to another further embodiment, a printed panel is provided to represent a shower enclosure as a backdrop for the sample miniature shower door assembly.

According to another further embodiment, a display rack is supported upon the door.

According to an even further embodiment, an array of seals is received within the display rack.

According to another further embodiment, an array of sweeps is received within the display rack.

According to another embodiment, a method is provided by stocking a shower door assembly package within a display opening. A door is closed to at least partially cover the shower door assembly package.

According to yet another embodiment, a door is opened to a shower door display. A shower door assembly package is removed from an opening in the shower door display.

According to yet another embodiment, a retail display assembly is provided with a display with a display opening to receive a plurality of shower door assembly packages within the display opening. An information panel at least partially covers at least one of the plurality of shower door assembly packages.

According to another embodiment, a method stocks a shower door assembly package within a display opening. An informational panel is moved to at least partially cover the shower door assembly package.

According to yet another embodiment, a method moves an information panel of a shower door display to expose a display opening. A shower door assembly package is removed from the opening.

### BRIEF DESCRIPTION OF THE DRAWINGS

FIG. 1 is a perspective view of an upper region of a shower door assembly according to an embodiment;

FIG. 2 is an exploded perspective view of a roller assembly of the shower door assembly of FIG. 1;

FIG. 3 is a perspective view of a shower with the shower door assembly of FIG. 1 partially assembled;

FIG. 4 is an exploded perspective view of the roller assembly of the shower door assembly of FIG. 1 illustrating an assembly step;

FIG. 5 is an exploded perspective view of the roller assembly of the shower door assembly of FIG. 1 illustrating another assembly step;

FIG. 6 is a perspective view of an upper region of a shower door assembly according to another embodiment;

FIG. 7 is a perspective view of an upper region of a shower door assembly according to another embodiment;

FIG. 8 is a perspective view of an upper region of a shower door assembly according to another embodiment;

FIG. 9 is a perspective view of an upper region of a shower door assembly according to another embodiment;

FIG. 10 is a perspective view of an upper region of a shower door assembly according to another embodiment;

FIG. 11 is a perspective view of an upper region of a shower door assembly according to another embodiment;

FIG. 12 is a perspective view of a hardware cover of a shower door roller assembly according to an embodiment;

FIG. 13 is a perspective view of a shower door roller assembly according to an embodiment;

FIG. 14 is a perspective view of a hardware cover of a shower door roller assembly according to another embodiment;

FIG. 15 is a perspective view of an upper region of a shower door assembly according to another embodiment;

FIG. 16 is a perspective view of an upper region of a shower door assembly according to another embodiment;

FIG. 17 is a perspective view of an upper region of a shower door assembly according to another embodiment;

FIG. 18 is a perspective view of a retail display for shower door assemblies according to an embodiment; and

FIG. 19 illustrates information indicia according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc., are, in some instances, used herein to describe various elements, these elements should not be limited by these terms. These terms are only used to distinguish one element from another and are presented in order of introduction for a particular embodiment, and may vary in the introduction of various embodiments. For example, a first cover could be termed a second cover, and, similarly, a second cover could be termed a first cover, without departing from the scope of the various described embodiments. The first cover and the second cover are both covers, but they are not the same cover in the context of a particular embodiment.

Shower door assemblies are utilized with shower enclosures, and are designed to contain water within the enclosure and prevent it from spilling out onto a bathroom floor. Shower doors are typically made from glass, though some might employ acrylic, plastic, or any suitable pane. Glass doors can be clear, frosted, or patterned to offer varying degrees of privacy and style.

Shower door assemblies offer various options and styles. For example, sliding shower door assemblies consist of one or more panels that slide along a track. Sliding shower door assemblies are compact and conserve space by not requiring extra room to swing open. Hinged or swing shower door assemblies open outward on hinges. Swing shower door assemblies require adequate space to swing open but can provide a traditional look and ease in ingress and egress. Bi-fold shower door assemblies fold in on themselves and are optimal for very tight spaces. Frameless shower door assemblies are made of tempered glass with minimal metal framing, to offer a sleek, modern look that are easier to clean. Framed shower door assemblies include a metal frame that surrounds the glass, offering extra support and sometimes additional features like built-in hardware.

Shower door assemblies offer additional features and hardware. Handles are mounted on an edge of the door, or directly to the pane of the door. Handles come in various styles and finishes, from sleek chrome to brushed nickel. Rubber or silicone seals may be provided along the edges of shower doors to help prevent leaks and maintain water containment. For sliding doors, track subassemblies may include a top and sometimes a bottom track, to guide movement of the door. Some doors have built-in towel bars or hooks for added convenience, which may also be utilized as handles.

The design of a shower door can range from minimalist to ornate, depending on the overall bathroom decor. Clear glass doors can make a space feel larger and more open, while frosted or patterned glass can provide additional privacy. A selected shower door assembly combines functionality with aesthetics, helping to define a look and usability of the shower enclosure.

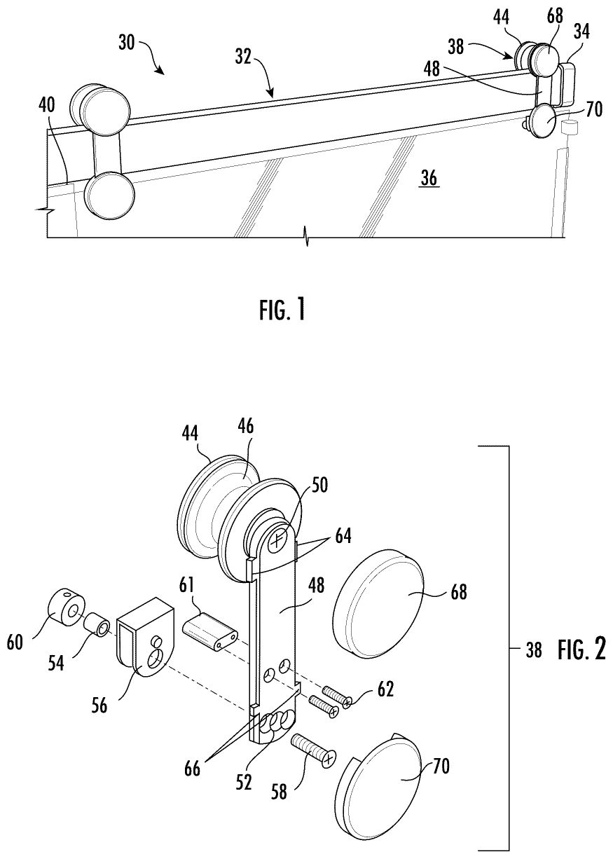

FIG. 1 illustrates an upper region of a shower door assembly 30 according to an embodiment. The shower door assembly 30 is a sliding shower door assembly 30. The shower door assembly 30 includes an upper rail 32. The upper rail 32 is sized to extend across a shower enclosure and is mounted to the enclosure by rail brackets 34. The shower door assembly 30 includes a shower door pane 36 supported upon the rail 32 by a pair of roller assemblies 38. The roller assemblies 38 cooperate with the rail 32 to translate along the rail 32 to open or close the shower door enclosure.

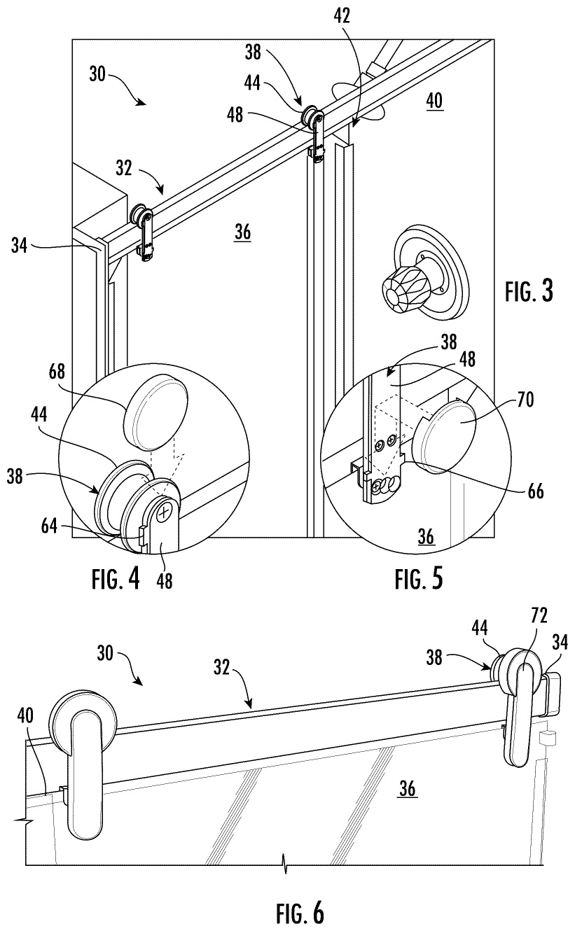

The shower door assembly 30 may also include a second shower door pane 40. The second shower door pane 40 may also be installed to the rail 32 by a pair of roller assemblies 42 (FIG. 3) to translate along the rail 32. To avoid interference between the pairs of roller assemblies 38, 42 the first pair of roller assemblies 38 is installed upon the rail 32 and the first shower door pane 36 is oriented outward relative to the shower enclosure. The second pair of roller assemblies 42 are installed to an inner track of the rail 32 and the second shower door pane 40 is oriented inward of the first shower door pane 36. Alternatively, the second shower door pane 40 may be a stationary or bypass door pane 40.

FIG. 2 illustrates one of the roller assemblies 38 in further detail. The roller assembly 38 includes a roller 44, which is a wheel with an internal bearing assembly. The roller 44 includes a groove 46 that is sized to receive a top portion of the rail 32 to roll along the rail 32 as a track or a guide. A bracket 48 is fastened to the roller 44 by a fastener 50, such as a threaded fastener 50, such as a screw 50. The roller 44 is connected to the bracket 48 for rotation relative to the bracket 48.

The bracket 48 extends a distance from the roller 44 to connect to the shower door pane 36. The bracket 48 includes an array of counter sunk holes 52, each at a different height to provide options for attaching the shower door pane 36 at one of the plurality of heights during installation.

A bushing 54 is provided and sized to be installed in an aperture in the shower door pane 36. A brace 56 is provided to extend over an edge of the shower door pane 36 aligned with the bushing 54 and one of the apertures 52. A fastener 58, such as a screw 58 is installed through one of the holes 52 in the bracket 48, through the brace 56, through the shower door pane 36 within the brace 56, and through the bushing 54 within the aperture in the shower door pane 36. Another threaded fastener 60, such as a nut 60, is provided on an inside of the shower door pane 36 to engage the screw 58 and to fasten the shower door pane 36 to the bracket 48.

Referring to FIGS. 1 and 3, the shower door assembly 30 has a design with exposed rollers 44 that roll on top of the rail 32. Although two roller assemblies 38 are illustrated, any suitable quantity of roller assemblies 38 may be employed. Once the rollers 44 are installed upon the rail 32, then a retainer 61 is fastened to the bracket 48 by fasteners 62 illustrated in FIG. 2. The retainer 61 is oriented below the rail 32 to maintain the rollers 44 in engagement with the rail 32 to prevent inadvertent removal and disassembly of the shower door pane 36 from the rail 32.

The bracket 48 has a generally uniform thickness, and may be fabricated from a sheet of metal, such as aluminum, brass, zinc, or the like. The bracket 48 also includes a common width along a majority of a length of the bracket 48. Two pairs of retainers 64, 66 extend outward from the width of the bracket 48. The retainers 64, 66 may be posts or lugs. A pair of covers 68, 70 are provided to cover the fasteners 50, 58, 62 of the roller assembly 38. The covers 68, 70 include slots to receive the bracket 48 and to cooperate with the corresponding retainers 64, 66 to fasten and retain the covers 68, 70 to the bracket 48. The retainers 64, 66 differ in size, and the covers 68, 70 may include corresponding slots to permit only one of the covers 68, 70 to be installed to one end of the bracket 48.

FIG. 4 illustrates that the cover 68 is installed on the bracket 48 by sliding a slot in the cover 68 upon the bracket 48 into engagement with the retainers 64. FIG. 5 illustrates that the cover 70 is installed on the bracket 48 by moving the cover 70 into engagement with the bracket 48 to receive the bracket 48 into a slot in the cover 70. Next, the cover 70 is slid downward as depicted until the retainers 66 fasten the cover 70 to the bracket 48. To remove the cover 68, the cover 68 is slid along the bracket 48 to disengage the slot from the retainers 64. To remove the cover 70, the cover 70 is slid upward until the retainers 66 are unfastened from the bracket 48. Then the cover 70 is moved away from the bracket 48.

With reference again to FIG. 1, the covers 68, 70 enclose the fasteners 50, 58, 62 of the roller assembly 38 to provide a clean appearance on an external surface to the hardware that is not obfuscated by fasteners 50, 58, 62. The covers 68, 70 may have a finish or appearance that is coordinated to match the bracket 48 and the rail 32 for a uniform appearance to the hardware of the shower door assembly 30. The upper cover 68 may also increase a profile of the roller wheel 44. The covers 68, 70 provide general protection to the fasteners 50, 58, 62 and a bearing assembly of the roller 44 from water or dust. A seal or gasket may be provided beneath each cover 68, 70 for a watertight connection.

FIG. 6 illustrates the shower door assembly 30 according to an embodiment. In FIG. 6, the covers 68, 70 are removed, and unitary covers 72 are provided on the brackets 48. Instead of a pair of covers 68, 70, one cover 72 is provided on each roller assembly 38. Each cover 72 has a profile that is sized to cover the bracket 48 and a portion of the roller 44. The covers 72 have a common mounting pattern as the covers 68, 70. The covers 72 demonstrate the modularity and interchangeability of the covers 68, 70, 72.

The covers 72 have a different design than the covers 68, 70 to permit customization of the roller assembly 38, and consequently the shower door assembly 30. Wherein the covers 68, 70 provided a pair of round shapes spaced by the bracket 48, the cover 72 promotes the outline of the bracket 48 beyond one round roller shape. The covers 68, 70, 72 may be retailed as a kit to permit the user to select one design, or to customize the design to coordinate, update, or refresh the appearance of the shower door assembly 30. The covers 68, 70, 72 may be packaged together with the shower door assembly 30, or may be retailed separately. The covers 68, 70, 72 are not load-bearing and can be interchanged manually without using tools. The covers 68, 70, 72 can be interchanged with minimal effort from the end user, and do not require removal of the shower door pane 36 from the rail 32. The covers 68, 70, 72 can differ in shape, design, size, color, finish, material, or any suitable design option.

FIG. 7 depicts the shower door assembly 30 with another interchangeable cover 74 with another design configuration. The cover 74 may be retailed separately or with other covers 68, 70, 72. The cover 74 promotes the bracket 48 shape by extending further upward than the bracket 48 and above the roller 44.

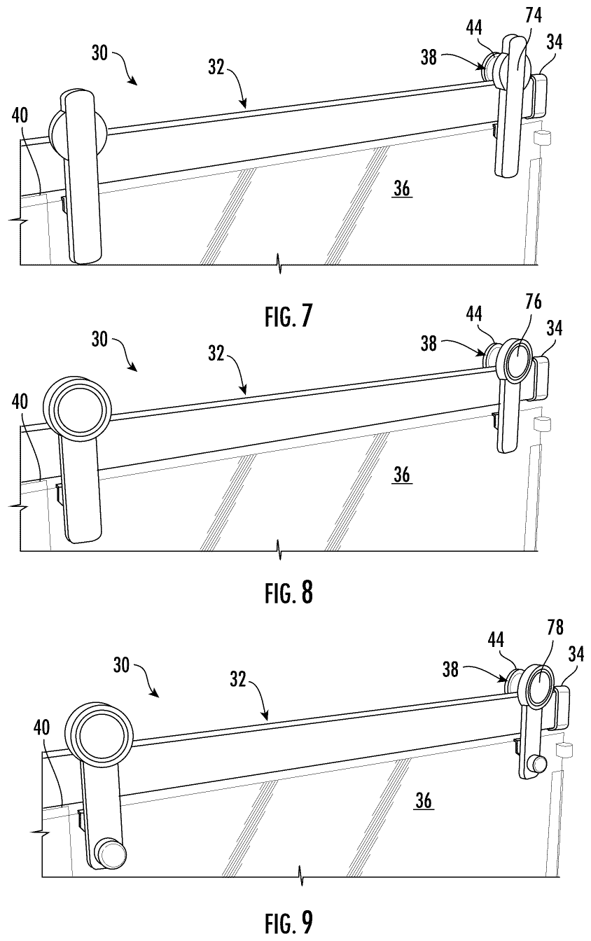

In FIG. 8, the shower door assembly 30 employs another interchangeable cover 76 with a prominent roller shape extending outward beyond a bracket shape. FIG. 9 illustrates a cover 78 similar to the cover 76 with an additional round shape indicative of a fastener head, or a cap for the fastener head.

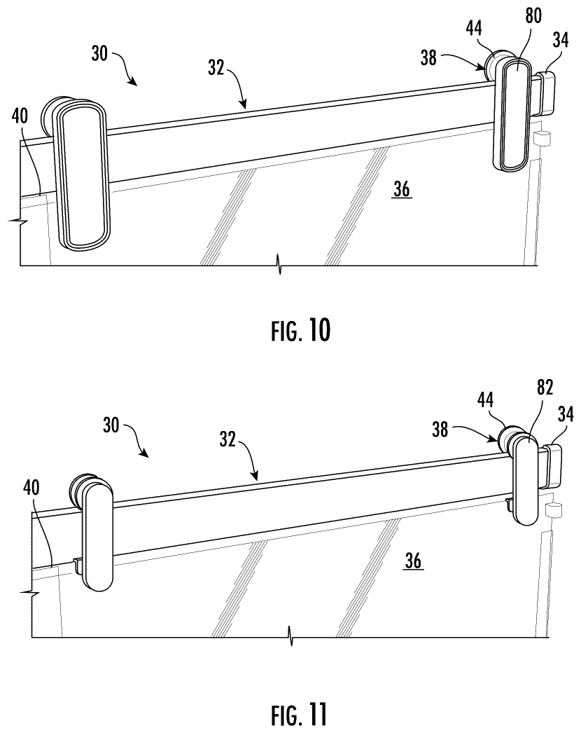

FIG. 10 illustrates the shower door assembly 30 with another interchangeable cover 80 with a profile that is an enlarged offset of the bracket 48 without tracing the roller 44. FIG. 11 illustrates the shower door assembly 30 in cooperation with an interchangeable cover 82 that is more streamlined and is undersized relative to the roller 44.

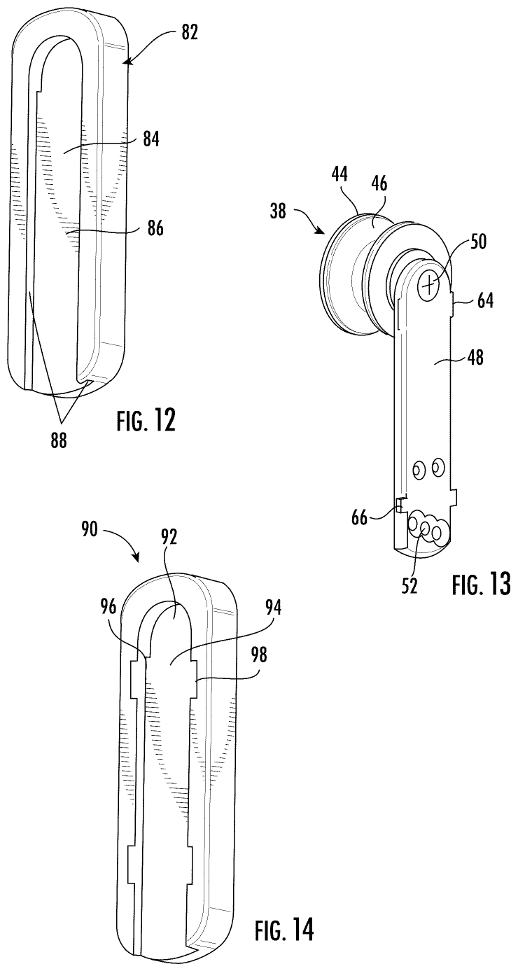

FIG. 12 illustrates an inside of the cover 82 according to an embodiment. The cover 82 includes a receptacle 84 sized to fasten to the bracket 48 of FIG. 13. The receptacle 84 may be standardized for utilization with a variety of roller assemblies 44. Likewise, each of the covers 68, 70, 72, 74, 76, 78, 80, 82 may include a common receptacle 84 for interchangeability of the covers 68, 70, 72, 74, 76, 78, 80, 82 for uniformity to the interaction with the bracket 48 and the retainers 64, 66. The receptacle 84 includes a primary slot 86 that is sized to receive the thickness, or a portion of the thickness, of the bracket 48. A pair of channels 88 are formed in the receptacle 84 to receive the retainers 64, 66 of the bracket 48.

FIG. 14 depicts a cover 90 according to another embodiment. The cover 90 includes a receptacle 92 for installation on the bracket 48. The receptacle 92 includes a slot 94 to receive a portion of the bracket 48 in the thickness direction of the bracket 48. A pair of channels 96 are formed in the receptacle 92 and are sized to receive the retainers 64, 66. Two pairs of notches 98 are formed in the receptacle 92. The notches 98 are spaced apart along the receptacle 92 with a spacing that matches a spacing of the retainers 64, 66. The notches 98 provide ingress of the retainers 64, 66 into the channels 96. The notches 98 permit installation of the cover 90 by horizontal translation of the cover 90 toward the bracket 48, with minimal vertical translation. The notches 98 limit a range of clearance for the cover 90 without requiring clearance above the rail 32 for a full length of the cover 90.

Various combinations of covers 68, 70, 72, 74, 76, 78, 80, 82, 90 may be retailed together or separately to allow for a consumer to change the look of their shower door assembly 30 by only changing out the covers 68, 70, 72, 74, 76, 78, 80, 82, 90.

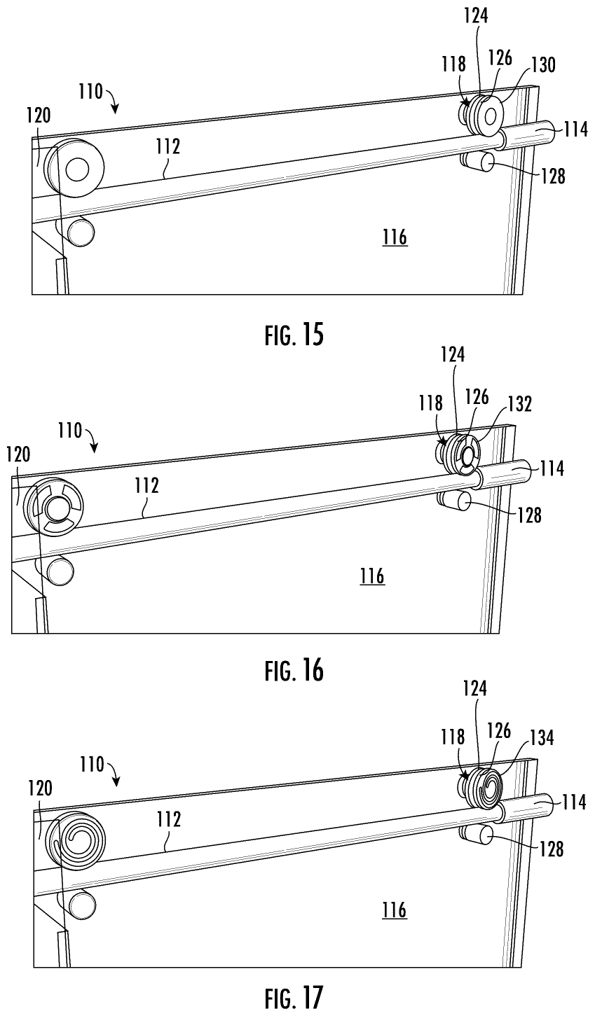

FIG. 15 illustrates an upper region of a shower door assembly 110 according to an embodiment. The shower door assembly 110 is a sliding shower door assembly 110. The shower door assembly 110 includes an upper rail 112. The upper rail 112 is sized to extend across a shower enclosure and is mounted to the enclosure by rail brackets 114. The shower door assembly 110 includes a shower door pane 116 supported upon the rail 112 by a pair of roller assemblies 118. The roller assemblies 118 cooperate with the rail 112 to translate along the rail 112 to open or close the shower door enclosure. The shower door assembly 110 may also include a second shower door pane 120. The second shower door pane 120 may also be installed to the rail 112 by a pair of roller assemblies to translate along the rail 112. Alternatively, the second shower door pane 120 may be a stationary or bypass door pane 120.

The roller assembly 118 includes a roller 124, which is a wheel with an internal bearing assembly. The roller 124 includes a groove 126 that is sized to receive a top portion of the rail 112 to roll along the rail 112 as a track or a guide. The shower door assembly 110 has a design with exposed rollers 124 that roll on top of the rail 112. Although two roller assemblies 118 are illustrated, any suitable quantity of roller assemblies 118 may be employed. Once the rollers 124 are installed upon the rail 112, then a retainer 128 is fastened to the shower door pane 116. The retainer 128 is oriented below the rail 112 to maintain the rollers 124 in engagement with the rail 112 to prevent inadvertent removal and disassembly of the shower door pane 116 from the rail 112.

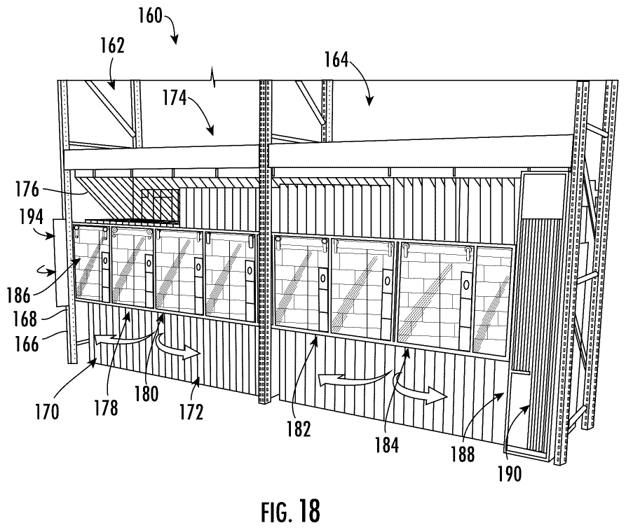

A decorative cap or cover 130 is installed directly to the roller 124 to rotate with the roller 124. The cover 130 has a round profile but could employ any suitable shape. The cover 130 is generally unadorned for a simplistic aesthetic. FIG. 16 illustrates the shower door assembly 110 with an interchangeable cover 132 installed on the rollers 124. The cover 132 has an asymmetrical aesthetic with a wheel hub appearance to provide a rotary appearance akin to a wheel as the rollers 124 are rotated during travel along the rail 112. The cover 134 in FIG. 17 is adorned with a spiral aesthetic to provide a rotating spiral appearance as the door pane 116 is opened or closed. The shower door assembly 110 allows for the covers 130, 132, 134 to rotate—and produce a rotating design aesthetic with the motion of the traversing door pane 116.

Shower door assemblies are often manufactured at one or more facilities, and then shipped to retail locations for retail. Alternatively, the shower door assemblies may be shipped directly to an end customer. The shower door assemblies are packaged for transportation to retail and to the end user. The shower door assemblies may be packaged with the shower door panes packaged separately from other components. Alternatively, shower door assemblies can be packaged with other features and hardware, such as handles, seals, track subassemblies, towel bars, or the like.

FIG. 18 illustrates a retail display assembly 160 according to an embodiment. The display assembly 160 is provided by, for example, a pair of retail shower door display subassemblies 162, 164. The display assembly 160 is sized to be displayed within a retail store aisle, such as a home improvement store. The display assembly 160 is utilized for both displaying and retailing shower door components. Each subassembly 162, 164 may be referred to as a bay 162, 164 that is separated by the applicable retail hardware, including posts 166. The posts 166 are spaced a width of each bay 162, 164, and a sequential pair of posts 166 define an opening 168 of each display bay 162, 164, to receive a plurality of shower door assembly packages 170, 172 within the display openings 168.

The openings 168 may also be bounded by shelving and/or signage 174 that is provided above the openings 168. The shelving and signage 174 may be connected to an array of dividers 176. The dividers 176 are incrementally spaced within the opening by a spacing that is greater than a width of one shower door assembly package 170, 172. The dividers 176 support the shower door assemblies laterally to prevent tipping or a collective build up of multiple packages 170, 172 leaning upon each other. The dividers 176 also help a consumer to retrieve one package 170, 172 without having to handle multiple adjacent packages 170, 172 in order to remove one package 170, 172.

Shower door assemblies 170, 172 are conventionally categorized by function, type, or size, and then style. For example, shower door assemblies include shower door assemblies 170 for utilization with tubs, and shower door assemblies 172 for utilization with dedicated shower enclosures. The first decision a consumer of shower door assemblies may need to decide is which style or category 170, 172 of shower door assembly is desired. Once the consumer selects a category 170, 172, the consumer then selects a size and a style. Size may include differing heights for different shower enclosure openings, and also differing widths for different shower enclosure openings, such as forty-eight inch and sixty inch shower enclosure openings.

Each retail subassembly 162, 164 includes information panels 178, 180, 182, 184 to assist a consumer in the selection and retail process. The information panels 178, 180, 182, 184 are each pivotally connected to one of the posts 166 to extend partially across one of the display openings 168. Collectively, the panels 178, 180, 182, 184 partially cover the shower door packages 170, 172. Each pair of panels 178, 180, and 182, 184 cooperate as saloon doors over each display opening 168. Each panel 178, 180, 182, 184 may include an auto-return, soft-close hinged connection with the corresponding post 166 so that if left open, the panels 178, 180, 182, 184 return to the closed display position depicted in FIG. 18.

Each panel 178, 180, 182, 184 includes information about the packaged shower door assemblies 170, 172. The panels 178, 180, 182, 184 include sample miniature shower door assemblies 186. The sample assemblies 186 permit consumers to visually and tactilely engage with the materials and styles of the packaged assemblies 170, 172 for selection of a packaged shower door assembly 170, 172. The sample assemblies 186 permit the consumer to slide or pivot panes in the sample assemblies 186 to experience the functionality of the applicable hardware. A printed drop-in may represent a typical shower enclosure as a backdrop for the sample assemblies 186.

The panels 178, 180, 182 each include two sample miniature shower door assemblies 186. The fourth panel 184 includes one sample miniature shower door assembly 186. The further panel 184 also includes a display rack 188 for seals, sweeps 190 or other replacement parts or accessories for the packaged shower door assemblies 170, 172.

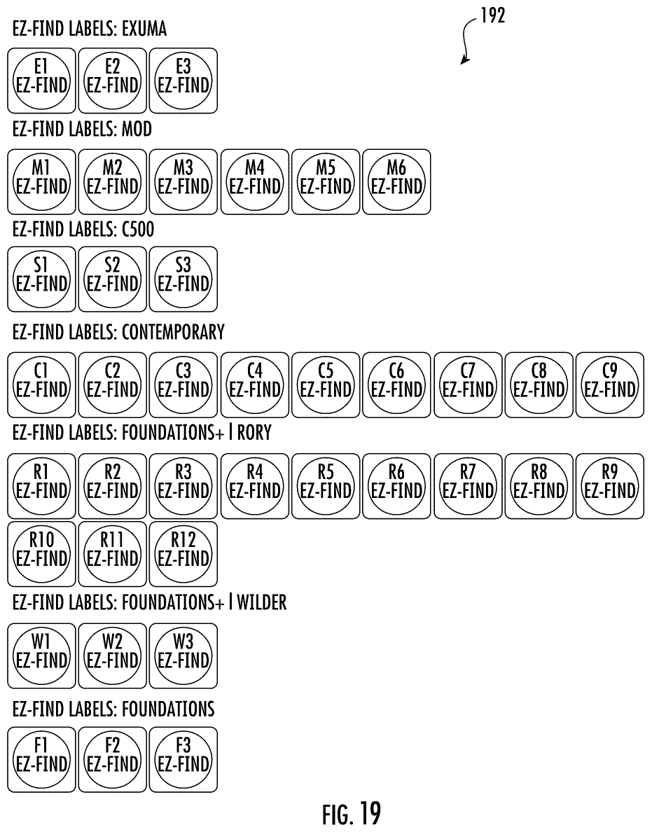

FIG. 19 illustrates an example of informational indicia on labels 192. Referring again to FIG. 18, the labels 192 are provided on the sample miniature shower assemblies 186 and the packaged shower door assemblies 170, 172 to assist a consumer in selecting and removing a packaged shower door assembly 170, 172. Additional instructional indicia may be provided on an instructional panel 194 attached to one of the posts 166. The labels 192 may also be reinforced on the instructional panel 194. Once a selection is made, the consumer pivots one of the panels 178, 180, 182, 184 away from the packages 170, 172 to open the bay 162, 164, and then removes one of the packaged shower door assemblies 170, 172 through the display opening 168.

In a retail context, visual connections between the product 170, 172 and the packaging are helpful to a consumer. Clear and intuitive design allows customers to easily identify and select the right product 170, 172, reducing confusion and frustration during the shopping process. With live examples 186 of shower doors 170, 172 available at the point of purchase, customers can see and feel the product, helping them to make more informed decisions. This hands-on experience not only streamlines the purchasing process but also significantly reduces the likelihood of returns, saving both time and money for the consumer.

The strategic wayfinding integrated into the display assembly 160 is also beneficial. By guiding customers directly to the products 170, 172 that meet their specific needs, the shopping experience becomes simpler and more convenient, leading to higher customer satisfaction. The ease of navigation and the ability to quickly find the desired product contribute to a positive in-store experience, encouraging repeat visits and brand loyalty.

For a retail associate, the display assembly 160 simplifies a replenishment process. The clear visual cues and organized display assembly 160 make it easier to identify which products 170, 172 need restocking, ensuring that product dividers 176 are well-stocked and ready for customers. This efficiency not only saves time for store associates but also ensures that the store maintains a professional appearance, which in turn supports a positive customer experience.

In addition, the educational aspects of the display assembly 160 are designed to empower both consumers and associates. By providing clear, concise information at the point of purchase, the display assembly 160 educates consumers on the benefits and features of each product, driving conversion rates. Associates are also better equipped to assist customers, as the display assembly 160 offers them the necessary tools to guide shoppers through the purchasing process confidently.

Overall, the display assembly 160 drives both education and conversion by creating an engaging, easy-to-navigate shopping environment that benefits both the customer and the associate, ultimately leading to increased sales and customer satisfaction.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features, such as various embodiments of the invention.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A kit comprising:
a first cover having a body sized to mount to hardware of a shower door assembly, the first cover having an external surface with a first design; and
a second cover having a body sized to mount to the hardware, the second cover having an external surface with a second design.

2. The kit of claim 1, wherein the first design has a first shape; and
wherein the second design has a second shape that is different than the first shape.

3. The kit of claim 1, wherein the first cover is provided with a second retainer to cooperate with a first retainer of the hardware to retain the first cover upon the hardware; and
wherein the second cover is provided with a third retainer to cooperate with the first retainer to retain the second cover upon the hardware.

4. The kit of claim 3, wherein the second retainer is provided with a slot sized to receive a lug of the hardware; and
wherein the third retainer is provided with a slot sized to receive the lug.

5. The shower door assembly of claim 4, wherein the first cover is provided with a first receptacle sized to receive a bracket of the hardware, and wherein the second retainer is provided in the first receptacle; and
wherein the second cover is provided with a second receptacle sized to receive the bracket, and wherein the third retainer is provided in the second receptacle.

6. A shower door assembly comprising:
a rail;
a first shower door pane;
a first roller assembly connected to the first shower door pane to support the first shower door pane for translation upon the rail, the first roller assembly comprising a first roller and first hardware; and
the kit of claim 1.

7. The shower door assembly of claim 6, wherein the hardware comprises a bracket.

8. The shower door assembly of claim 7, wherein the bracket further comprises a first retainer;
wherein the first cover is provided with a second retainer to cooperate with the first retainer to retain the first cover upon the bracket; and
wherein the second cover is provided with a third retainer to cooperate with the first retainer to retain the second cover upon the bracket.

9. The shower door assembly of claim 8, wherein the first retainer further comprises a pair of spaced apart retainers.

10. The shower door assembly of claim 8, wherein the first retainer further comprises a lug.

11. The shower door assembly of claim 10, wherein the second retainer is provided with a slot sized to receive the lug; and
wherein the third retainer is provided with a slot sized to receive the lug.

12. The shower door assembly of claim 11, wherein the first cover is provided with a first receptacle sized to receive the bracket, and wherein the second retainer is provided in the first receptacle; and
wherein the second cover is provided with a second receptacle sized to receive the bracket, and wherein the third retainer is provided in the second receptacle.

13. The shower door assembly of claim 8, further comprising a second roller assembly connected to the first shower door pane to support the first shower door pane for translation upon the rail, the second roller assembly comprising a second roller and second hardware.

14. The shower door assembly of claim 8, further comprising:
a second shower door pane; and
a second roller assembly connected to the second shower door pane to support the second shower door pane for translation upon the rail.

15. (canceled)

16. A method of decorating a shower door assembly comprising:
removing a first cover from hardware of a shower door assembly; and
installing a second cover upon the hardware with a design that is different from a design of the first cover.

17. The method of claim 16, further comprising:
sliding the first cover along the hardware to unfasten the hardware.

18. The method of claim 17, further comprising:
moving the first cover away from the hardware to remove the hardware from a slot within the first cover.

19. A retail display assembly comprising:
a post defining one end of a display opening to receive a plurality of shower door assembly packages within the display opening; and
a door pivotally attached to the post to at least partially cover at least one of the plurality of shower door assembly packages.

20. The retainer display assembly of claim 19, further comprising an information panel supported upon the door.

21. The retail display assembly of claim 19, further comprising a sample miniature shower door assembly supported upon the door.

22-30. (canceled)
